(19) United States
(12) Patent Application Publication
(10) Pub. No.: US 2015/0229659 A1
(43) Pub. Date: Aug. 13, 2015

(54) PASSIVE DETECTION OF MALICIOUS NETWORK-MAPPING SOFTWARE IN COMPUTER NETWORKS

(71) Applicant: GUARDICORE LTD., Tel Aviv (IL)

(72) Inventors: Itamar Tal, Givatayim (IL); Ariel Zeitlin, Kfar Saba (IL); Pavel Gurvich, Tel Aviv (IL); Ofri Ziv, Tel Aviv (IL)

(21) Appl. No.: 14/596,240

(22) Filed: Jan. 14, 2015

Related U.S. Application Data
(60) Provisional application No. 61/939,282, filed on Feb. 13, 2014.

(51) Int. Cl. H04L 29/06; G06F 9/455

(52) U.S. Cl. CPC H04L 63/1416; G06F 9/45533

(57) ABSTRACT

A method includes, in a computer network that includes multiple endpoints, configuring a network element to forward one or more specified packets from a selected endpoint to a detection unit. A malicious network-mapping software running on the selected endpoint is identified by analyzing the forwarded packets in the detection unit.

### CROSS-REFERENCE TO RELATED APPLICATIONS

This application claims the benefit of U.S. Provisional Patent Application 61/939,282, filed Feb. 13, 2014, whose disclosure is incorporated herein by reference.

### FIELD OF THE INVENTION

The present invention relates generally to network security, and particularly to methods and systems for detection of network-mapping software.

### SUMMARY OF THE INVENTION

An embodiment of the present invention that is described herein provides a method including, in a computer network that includes multiple endpoints, configuring a network element to forward one or more specified packets from a selected endpoint to a detection unit. A malicious network-mapping software running on the selected endpoint is identified by analyzing the forwarded packets in the detection unit.

In some embodiments, configuring the network element includes instructing the network element to send to the selected endpoint a packet that is expected to be discarded by a network interface of the selected endpoint unless the network interface operates in a promiscuous mode, and identifying the network-mapping software includes detecting that the selected endpoint responded to the packet. In some embodiments, configuring the network element includes instructing the network element to send to the selected endpoint a packet having a layer-2 address that does not match the layer-2 address of the selected endpoint, and identifying the network-mapping software includes detecting that the selected endpoint responded to the packet.

In some embodiments, configuring the network element includes instructing the network element to forward to the detection unit reverse name resolution queries initiated by the selected endpoint, and identifying the network-mapping software includes analyzing the reverse name resolution queries. Identifying the network-mapping software may include detecting that a rate of the reverse name resolution queries exceeds a threshold. Additionally or alternatively, identifying the network-mapping software may include detecting that at least one of the reverse name resolution queries specifies an address in a same subnet as the selected endpoint.

In another embodiment, configuring the network element includes instructing the network element to forward to the detection unit sniffing announcement packets. In yet another embodiment, configuring the network element includes configuring a physical or virtual network switch.

There is additionally provided, in accordance with an embodiment of the present invention, a method including configuring a software module that runs on a node of a computer network to directly access a memory of a Virtual Machine (VM) running on the node. A malicious network-mapping software running in the VM is identified using the software module, by directly accessing the memory of the VM.

In an embodiment, identifying the network-mapping software includes comparing a process running in the memory of the VM to one or more known network-mapping processes. In another embodiment, identifying the network-mapping software includes accessing a virtual network interface in the memory of the VM, and detecting that the virtual network interface is operating in promiscuous mode.

There is also provided, in accordance with an embodiment of the present invention, an apparatus including an interface and a processor. The interface is configured for communicating with a computer network that includes multiple endpoints. The processor is arranged to configure a network element in the computer network to forward one or more specified packets from a selected endpoint to the apparatus, and to identify a malicious network-mapping software running on the selected endpoint by analyzing the forwarded packets.

There is further provided, in accordance with an embodiment of the present invention, a computer software product, the product including a tangible non-transitory computer-readable medium in which program instructions are stored, which instructions, when read by a processor of a detection unit that is connected to a computer network including multiple endpoints, cause the processor to configure a network element in the computer network to forward one or more specified packets from a selected endpoint to the detection unit, and to identify a malicious network-mapping software running on the selected endpoint by analyzing the forwarded packets.

The present invention will be more fully understood from the following detailed description of the embodiments thereof, taken together with the drawings in which:

### BRIEF DESCRIPTION OF THE DRAWINGS

FIGS. 1A and 1B are block diagrams that schematically illustrates computer networks, in accordance with embodiments of the present invention; and

FIGS. 2-4 are flow charts that schematically illustrate methods for sniffer detection, in accordance with embodiments of the present invention.

### DETAILED DESCRIPTION OF EMBODIMENTS

### Overview

Some attacks on computer networks involve passive mapping of the network. In a typical scenario, an attacker penetrates the network, gains access to a certain network endpoint, and then uses the endpoint to run network-mapping software. Such software, also referred to as “network sniffer,” monitors network traffic and obtains information such as network topology, endpoint addresses or other information that is useful for the attacker. The network-mapping software typically monitors the network traffic passively, and is therefore difficult to detect.

Embodiments of the present invention that are described herein provide improved methods and systems for detecting malicious network-mapping software running on a network endpoint. In some embodiments, a sniffer detection unit configures certain network elements to forward specified packets to selected endpoints, and/or to forward specified packets from selected endpoints to the detection unit. The detection unit identifies suspected network-mapping activity by analyzing the forwarded packets.

In some embodiments, the sniffer detection unit assumes that the network-mapping software sets the network interface of the endpoint to promiscuous mode, in which the network interface does not perform layer-2 filtering of incoming packets. For example, the sniffer detection unit may configure the network element to forward to a selected endpoint a packet whose layer-2 address does not match the layer-2 address of the endpoint. The packet is chosen to be of a type that solicits the endpoint operating system to respond, and the network element is further configured to forward the response to the sniffer detection unit. If the endpoint responds to the packet, the sniffer detection unit concludes that the endpoint network interface operates in promiscuous mode, and the endpoint is therefore suspected of running network-mapping software.

In other embodiments, the sniffer detection unit assumes that the network-mapping software performs reverse name resolution, i.e., translates monitored network addresses into domain names that are more legible to the attacker. Thus, the sniffer detection unit configures the network element to forward reverse name resolution queries initiated by endpoints. If, for example, a certain endpoint is found to send a large number of reverse name resolution queries, and/or reverse name resolution queries that specify addresses in the same subnet as the endpoint, the endpoint is suspected of running network-mapping software.

In yet other embodiments, the sniffer detection unit configures the network element to forward “sniffing announcement” packets, which are characteristically sent by some administrative tools that could be used for malicious sniffing.

The sniffer detection methods described herein are highly effective in identifying unauthorized network-mapping activity in the network, even though such activity is usually passive and unobtrusive. The disclosed techniques can be implemented in various types of computer networks, including, for example, networks that host Virtual Machines (VMs) using virtual switches and Software-Defined Networks (SDNs).

### System Description

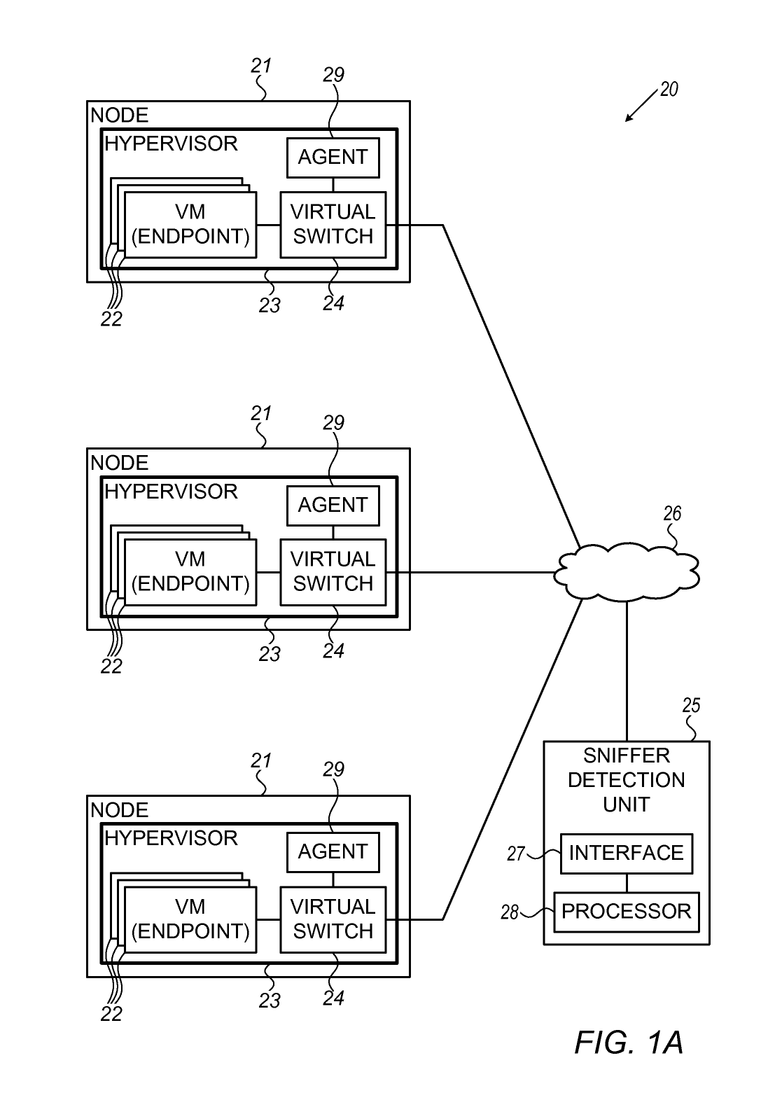

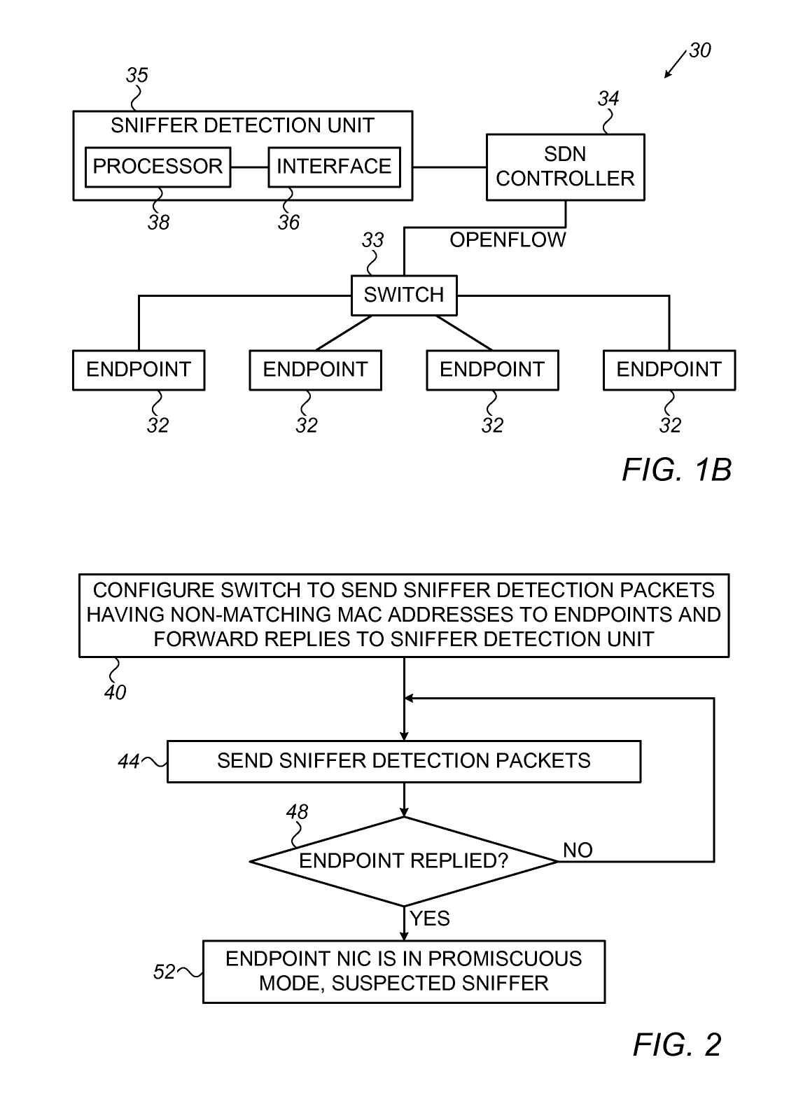

FIG. 1A is a block diagram that schematically illustrates a computer network 20, in accordance with an embodiment of the present invention. Network 20 may implement, for example, a virtualized data center, a

High-Performance Computing (HPC) network, or any other suitable application. In the present example, network 20 comprises multiple compute nodes 21, such as servers, interconnected by a communication network 26. The figure shows three node for simplicity, but real-life networks typically comprise a large number of nodes.

Each node 21 comprises a hypervisor 23 that hosts one or more Virtual Machines (VMs) 22. The VMs are also referred to herein as endpoints. Each hypervisor further runs a virtual switching fabric that comprises one or more interconnected virtual network switches 24 and/or virtual bridges, via which the VMs of the node communicate with one another and with VMs or other entities external to the node. FIG. 1A shows a single switch 24 in each hypervisor for the sake of clarity. Real-life implementation will often comprise multiple interconnected virtual switches and/or virtual bridges per hypervisor.

In some embodiments, system 20 comprises a sniffer detection unit 25, which detects malicious network-mapping software that may run on one or more of the endpoints (VMs 22). Example sniffer detection methods are described in detail with reference to FIGS. 2-4 below. Unit 25 comprises an interface 27 for communicating with the computer network, and a processor 28 that is configured to carry out the methods described herein.

Among other tasks, processor 28 is capable of configuring switches 24 to forward certain packets or flows from the sniffer detection unit to selected VMs, and to forward certain packets or flows from selected VM to the sniffer detection unit. In some embodiments, this capability is used as part of security processes for detecting unauthorized network-mapping activity in the network, as will be described below.

In some embodiments, at least some of the functionality of sniffer detection unit 25 is distributed among nodes 21. In these embodiments, each hypervisor runs a respective detection agent 29—A software component that performs some or even all of the sniffer detection tasks. In some embodiments that are described further below, agents 29 detect network-mapping software using VM memory introspection, i.e., by directly accessing the VM memory.

FIG. 1B is a block diagram that schematically illustrates a computer network 30, in accordance with an alternative embodiment of the present invention. In the present example, network 30 comprises a Software-Defined Network (SDN). Network 30 comprises multiple endpoints 32 and one or more network switches 33. The figure shows a single switch and four endpoints, for simplicity, but real-life networks typically comprise a large number of switches and endpoints.

Endpoints 32 may comprise physical machines such as servers, workstations, personal computers or mobile computing devices. Additionally or alternatively, endpoints 24 may comprise VMs or any other suitable endpoint type. Switches 33 may comprise physical switches and/or virtual switches (sometime referred to as soft-switches). Hybrid configurations that comprise both physical and virtual endpoints, and/or both physical and virtual switches, are also feasible.

In the example of FIG. 1B, network 30 comprises an SDN controller 34 that controls and configures switches 33 using a suitable protocol such as OpenFlow or OnePK. OpenFlow is specified, for example, in “OpenFlow Switch Specification, Version 1.1.0 Implemented (Wire Protocol 0x02)”, Feb. 28, 2011, which is incorporated herein by reference. OnePK is described, for example, in “One Platform Kit (onePK) for Developers,” March, 2014, which is incorporated herein by reference.

Among other tasks, controller 34 is capable of configuring switch 33 to forward certain packets or flows to selected endpoints, and to forward certain packets or flows from selected endpoints back to the SDN controller. In some embodiments, this capability is used as part of security processes for detecting unauthorized network-mapping activity in the network, as will be described below.

In some embodiments, system 20 comprises a sniffer detection unit 35, which detects malicious network-mapping mapping software that may run on one or more of endpoints 32. Example sniffer detection methods are described in detail with reference to FIGS. 2-4 below. Unit 35 comprises an interface 36 for communicating with the computer network (in the present example with SDN controller 34), and a processor 38 that is configured to carry out the methods described herein.

The configurations of systems 20 and 30 shown in FIGS. 1A and 1B are example configurations that are depicted purely for the sake of conceptual clarity. In alternative embodiments, any other suitable system configuration can be used. For example, detection unit 35 is shown in FIG. 1B as a standalone unit. In alternative embodiments, unit 35 may be implemented as a software application that runs on SDN controller 34 and uses the existing interfaces of the SDN controller for connecting to the network. Other alternative embodiments, relating to various ways of configuring switches 24 or 33 or other network elements to perform the disclosed techniques, are addressed further below.

The different system elements shown in FIGS. 1A and 1B may be implemented using any suitable hardware, such as in an Application-Specific Integrated Circuit (ASIC) or Field-Programmable Gate Array (FPGA). Alternatively, the various system elements can be implemented using software, or using a combination of hardware and software elements.

In some embodiments, sniffer detection unit 25, sniffer detection unit 35, switches 24 and/or switch 33 may comprise one or more processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Sniffer Detection by Network Element Configuration

In some embodiments, the sniffer detection unit (25 or 35) analyzes communication traffic in the system in order to identify malicious network-mapping software that may run on one or more of the endpoints (22 or 32). Typically, the processor of the sniffer detection unit configures one or more network elements in the system to forward to the sniffer detection unit specified packets from one or more selected endpoints. The processor detects suspected network-mapping software by analyzing the forwarded packets.

The type of network element or elements being configured, and the manner in which they are configured, varies depending on the network configuration and on the specific sniffer detection scheme.

In some embodiments, the network element being configured is the same (physical or virtual) switch that switches the normal communication traffic of the endpoints (e.g., switch 24 in FIG. 1A or switch 33 in FIG. 1B). In other embodiments, the network element being configured is a dedicated network element that is added to the system for performing security functions, in addition to the switches that switch the normal communication traffic. Such an additional network element may be physical or virtual, and may comprise a switch or any other suitable type of network element.

Consider, for example, the embodiment of FIG. 1A in which virtual switch 24 runs in the same physical machine as the VMs it serves. In such an embodiment, a dedicated network element (e.g., a dedicated virtual switch) may be added between the VMs and switch 24. The dedicated network element may be implemented, for example, in hypervisor 23 that hosts the VMs and runs switch 24. This dedicated network element is able to access the traffic between the endpoints and the network, and to forward packets to the endpoints directly, under control of sniffer detection unit 25.

Additionally or alternatively, the sniffer detection unit may configure any other suitable network element in the system to perform the disclosed techniques in any other suitable manner. As noted above, in some embodiments the functionality of the sniffer detection unit is distributed among agents 29 in the various hypervisors of nodes 21. In such embodiments, a given agent 29 typically configures its respective switch 24 to forward specified packets between the VMs and the agent.

### Example Sniffer Detection Methods

The description below presents several example sniffer detection schemes. The embodiments described below refer to FIG. 1A, in which the network elements being configured are virtual switches 24. This choice, however, is made purely by way of example. The disclosed techniques can be carried out in a similar manner in any other suitable system configuration, such as the SDN configuration of FIG. 1B.

In any of the methods described herein, the sniffer detection application may initiate any desired action in response to detecting suspected network-mapping software on a given endpoint. Example actions may comprise placing the suspected endpoint or the suspected software in quarantine, extracting the process suspected of performing sniffing for forensic research, triggering an alert, notifying an administrator, or any other suitable actions.

### Sniffer Detection by Detecting Network Interface Set to Promiscuous Mode

FIG. 2 is a flow chart that schematically illustrates a method for sniffer detection, in accordance with an embodiment of the present invention. In this example, the sniffer detection unit tests whether the network interface (e.g., physical or virtual NIC) of a selected endpoint is set to normal operation mode or to promiscuous mode.

In normal operation mode, the network interface typically discards packets that are not addressed to the layer-2 address of the network interface (e.g., Medium Access Control (MAC) address or Ethernet address). In promiscuous mode, the network interface allows all packets to pass through to the endpoint, regardless of their layer-2 addresses. As such, it is expected that a network sniffer will operate the network interface in promiscuous mode in order to monitor network traffic. Thus, a network interface that operates in promiscuous mode is highly indicative of suspected network-mapping software.

The method of FIG. 2 begins with the sniffer detection unit configuring the switch, at a switch configuration step 40. The switch is configured to forward “sniffer detection packets” from the sniffer detection unit to one or more selected endpoints, and to forward replies received from the endpoints back to the sniffer detection unit.

For testing a given endpoint, the sniffer detection unit typically learns the layer-2 address and IP address of the endpoint, and then generates a suitable sniffer detection packet tailored for that endpoint.

Typically, the sniffer detection packet is sent with a destination layer-2 address that does not match the layer-2 addresses of the endpoint network interface. In addition, the sniffer detection packet is chosen to be of a type that solicits the endpoint operating system to respond in some observable way, e.g., an ICMP echo request. In some embodiments, the sniffer detection packet is sent with a multicast IP address, because some operating systems do not respond to unicast IP packets having invalid layer-2 addresses.

The switch forwards the sniffer detection packets to the selected endpoints, at a packet forwarding step 44, and forwards any responses to the sniffer detection unit. The sniffer detection unit checks whether an endpoint has replied to a sniffer detection packet, at a response checking step 48.

If a given endpoint responded to the sniffer detection packet, the sniffer detection unit concludes that the endpoint network interface operates in promiscuous mode (since otherwise the endpoint network interface would have dropped the sniffer detection packet due to the mismatch in layer-2 address). In such a case, the sniffer detection unit regards the endpoint as suspected of running network-mapping software, at a suspected termination step 52.

In various embodiments, the sniffer detection unit may learn the endpoint addresses by collecting packets using any suitable protocol. In the SDN embodiment of

FIG. 1B, for example, the protocol may comprise OpenFlow, OnePK, NetFlow, sFlow, IPFIX, or any other suitable protocol. The sniffer detection unit may configure the switch to forward the sniffer detection packets to the endpoints using any suitable protocol mechanism, e.g., using OpenFlow PACKET OUT. This mechanism overrides the normal switch functionality of dropping packets having non-matching layer-2 addresses. The sniffer detection unit may configure the switch to forward the replies to the sniffer detection unit using any suitable protocol mechanism, e.g., using OpenFlow FlowMod and PACKET_IN messages. After the detection process is completed, any added flows can be removed.

In some embodiments, the method of FIG. 2 may be repeated at periodic intervals, or applied alternately to various endpoints in the network, in order to achieve adequate coverage and detection probability. In an example implementation, the detection unit sends sniffer detection packets periodically via all ports of switch 24 that are known to be directly connected to live endpoints, e.g., using PACKET OUT messages.

In some embodiments, the sniffer detection unit sends multiple different sniffer detection packets to a given endpoint. Multiple packets may be sent, for example, when the switch cannot determine the exact operating-system type and/or version of the endpoint, and therefore sends a respective sniffer detection packet per each possible version and/or type.

Additionally or alternatively to the method of FIG. 2, the sniffer detection unit may verify whether the network interface of a selected endpoint operates in promiscuous mode using any other suitable technique.

### Sniffer Detection by Detecting Reverse Name Resolution Queries

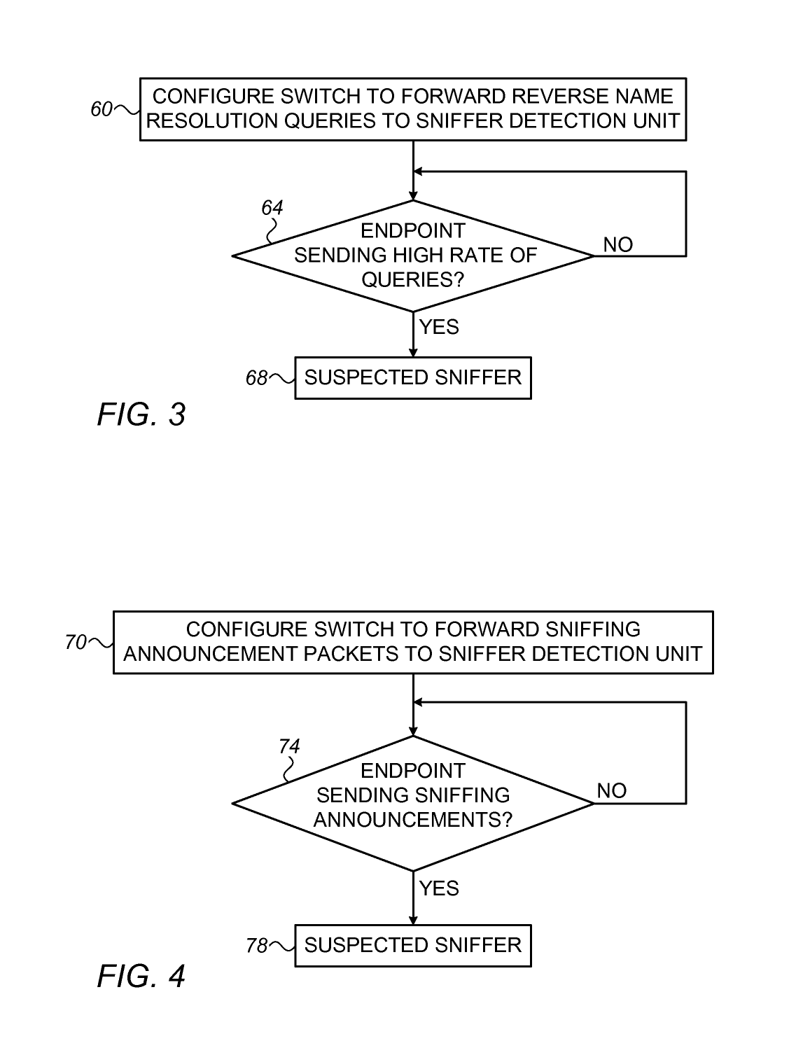

FIG. 3 is a flow chart that schematically illustrates a method for sniffer detection, in accordance with another embodiment of the present invention. In this example, the sniffer detection unit detects network-mapping software by identifying an endpoint that initiates reverse name resolution queries.

The rationale behind this technique is that a network sniffer may translate the monitored IP addresses into domain names that are more readable and legible to the human attacker. Reverse name resolution queries are generally rare, and a large volume or rate of such queries is highly indicative of network-mapping activity.

The method of FIG. 3 begins with the sniffer detection unit configuring the switch to forward reverse name resolution queries initiated by endpoints, at a switch configuration step 60. In SDN implementations, this configuration may be performed, for example, using OpenFlow PACKET_IN messages.

Various name resolution protocols and services are available for translating between domain names and IP addresses. Example services include Domain Name Service (DNS) and NetBIOS Name Service (NBNS). In DNS, reverse name resolution queries are referred to as PTR queries. The method of FIG. 3 can be used for detecting queries of any such protocol, or any other suitable protocol.

At a query checking step 64, the sniffer detection unit checks whether an endpoint initiated suspicious reverse name resolution queries. If so, the sniffer detection unit regards the endpoint as suspected of running network-mapping software, at a suspected termination step 68.

The sniffer detection unit may use any suitable criterion for deciding whether the detected reverse name resolution queries are suspicious or innocent. If, for example, an endpoint sends reverse name resolution queries at a rate that exceeds a threshold, the endpoint is suspected of running network-mapping software.

As another example, the sniffer detection unit may declare an endpoint as suspicious if the endpoint sends reverse name resolution queries that specify addresses in the same subnet as the endpoint. Reverse name resolution queries for nearby endpoints in the same subnet are highly unexpected, and can be attributed to network sniffing with high likelihood.

### Sniffer Detection by Detecting Sniffing Announcement Packets

Some commercial network monitoring tools used by network administrators send out “sniffing announcement packets” over the network to announce that network tracing is in progress. When the network tracing session ends, the tool sends another sniffing announcement packet. Packets of this sort are used, for example, by the Microsoft Network Monitor installed on Windows servers.

In some cases, an attacker may misuse a commercial network monitoring tool of this sort as malicious network-mapping software. In some embodiments, the sniffer detection unit detects such network-mapping activity by detecting sniffing announcement packets sent from endpoints.

FIG. 4 is a flow chart that schematically illustrates a method for sniffer detection, in accordance with yet another embodiment of the present invention. The method begins with the sniffer detection unit configuring the switch to forward sniffing announcement packets to the sniffer detection unit, at a configuration step 70.

A Microsoft Network Monitor sniffing announcement packet, for example, is a UDP packet having a distinct port number. When using OpenFlow control in SDN implementations, for example, the switch may be configured to match incoming flows to such attributes, and redirect matching packets to the SDN controller.

At an announcement checking step 74, the sniffer detection unit checks for an endpoint that sends suspicious sniffing announcement packets. If such an endpoint is detected, the sniffer detection unit declares the endpoint suspected of running malicious network-mapping software, at a malicious termination step 78.

Since the sniffing announcement packets originate from a commercial tool that may be used legitimately or illegitimately, in some embodiments the sniffer detection unit employs additional measures for distinguishing between innocent network tracing and malicious network mapping. For example, the sniffer detection unit may detect the process that initiated the announcement. If the announcement is initiated by an authenticated log-in process, i.e., by a legitimate human user, then it may be innocent. If the announcement is initiated by some unrecognized process, then it is likely to be malicious.

### Sniffer Detection Using VM Memory Introspection

In some embodiments, the module used for sniffer detection on a given node is implemented in software in the same hypervisor that runs the VMs (endpoints) of the node. One example of such modules is agents 29 of FIG. 1A. As explained above, a given agent 29 is able to access the memory spaces used by the VMs directly. In some embodiments, agent 29 uses this access for detecting suspected network-mapping software. The description that follows demonstrates this technique with reference to the configuration of FIG. 1A, in which agent 29 of a given node runs in hypervisor 23 of the node and is able to access the memory of VMs 22 running on the node.

In an example embodiment, agent 29 first determines the operating system and possibly the operating-system version of VM 22. This information can be obtained either using directly, e.g., by examining the VM memory, or indirectly, e.g., from some cloud management service or other external entity.

Using the operating-system information, agent 29 is able to extract the list of running VM processes. The agent then examines the processes in the VM memory, and compares them with images or other attributes of known sniffing processes. Upon detecting a similarity, agent 29 may conclude that a given process is a network-mapping software.

As another example, agent 29 may examine the memory of the VM corresponding to the VM's virtual NIC, and identify whether the virtual NIC operates in promiscuous mode. As explained with reference to FIG. 2 above, a NIC that operates in promiscuous mode is highly indicative of a sniffer.

Further alternatively, agent 29 may use VM memory introspection to detect network-mapping software in any other suitable way. Having detected a suspected network-mapping software, agent 29 may take suitable action autonomously (e.g., quarantine the process in question) and/or notify unit 25.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a computer network that comprises multiple endpoints, configuring a network element to forward one or more specified packets from a selected endpoint to a detection unit; and
identifying a malicious network-mapping software running on the selected endpoint, by analyzing the forwarded packets in the detection unit.

2. The method according to claim 1, wherein configuring the network element comprises instructing the network element to send to the selected endpoint a packet that is expected to be discarded by a network interface of the selected endpoint unless the network interface operates in a promiscuous mode, and wherein identifying the network-mapping software comprises detecting that the selected endpoint responded to the packet.

3. The method according to claim 1, wherein configuring the network element comprises instructing the network element to send to the selected endpoint a packet having a layer-2 address that does not match the layer-2 address of the selected endpoint, and wherein identifying the network-mapping software comprises detecting that the selected endpoint responded to the packet.

4. The method according to claim 1, wherein configuring the network element comprises instructing the network element to forward to the detection unit reverse name resolution queries initiated by the selected endpoint, and wherein identifying the network-mapping software comprises analyzing the reverse name resolution queries.

5. The method according to claim 4, wherein identifying the network-mapping software comprises detecting that a rate of the reverse name resolution queries exceeds a threshold.

6. The method according to claim 4, wherein identifying the network-mapping software comprises detecting that at least one of the reverse name resolution queries specifies an address in a same subnet as the selected endpoint.

7. The method according to claim 1, wherein configuring the network element comprises instructing the network element to forward to the detection unit sniffing announcement packets.

8. The method according to claim 1, wherein configuring the network element comprises configuring a physical or virtual network switch.

9. A method, comprising:
configuring a software module that runs on a node of a computer network to directly access a memory of a Virtual Machine (VM) running on the node; and
using the software module, identifying a malicious network-mapping software running in the VM, by directly accessing the memory of the VM.

10. The method according to claim 9, wherein identifying the network-mapping software comprises comparing a process running in the memory of the VM to one or more known network-mapping processes.

11. The method according to claim 9, wherein identifying the network-mapping software comprises accessing a virtual network interface in the memory of the VM, and detecting that the virtual network interface is operating in promiscuous mode.

12. An apparatus, comprising:
an interface for communicating with a computer network that comprises multiple endpoints; and
a processor, which is arranged to configure a network element in the computer network to forward one or more specified packets from a selected endpoint to the apparatus, and to identify a malicious network-mapping software running on the selected endpoint by analyzing the forwarded packets.

13. The apparatus according to claim 12, wherein the processor is arranged to instruct the network element to send to the selected endpoint a packet that is expected to be discarded by a network interface of the selected endpoint unless the network interface operates in a promiscuous mode, and to identify the network-mapping software by detecting that the selected endpoint responded to the packet.

14. The apparatus according to claim 12, wherein the processor is arranged to instruct the network element to send to the selected endpoint a packet having a layer-2 address that does not match the layer-2 address of the selected endpoint, and to identify the network-mapping software by detecting that the selected endpoint responded to the packet.

15. The apparatus according to claim 12, wherein the processor is arranged to instruct the network element to forward reverse name resolution queries initiated by the selected endpoint, and to identify the network-mapping software by analyzing the reverse name resolution queries.

16. The apparatus according to claim 15, wherein the processor is arranged to identify the network-mapping software by detecting that a rate of the reverse name resolution queries exceeds a threshold.

17. The apparatus according to claim 15, wherein the processor is arranged to identify the network-mapping software by detecting that at least one of the reverse name resolution queries specifies an address in a same subnet as the selected endpoint.

18. The apparatus according to claim 12, wherein the processor is arranged to instruct the network element to forward sniffing announcement packets.

19. The apparatus according to claim 12, wherein the network element comprises a physical or virtual network switch.

20. A computer software product, the product comprising a tangible non-transitory computer-readable medium in which program instructions are stored, which instructions, when read by a processor of a detection unit that is connected to a computer network comprising multiple endpoints, cause the processor to configure a network element in the computer network to forward one or more specified packets from a selected endpoint to the detection unit, and to identify a malicious network-mapping software running on the selected endpoint by analyzing the forwarded packets.
